(19) United States
(12) Patent Application Publication
(10) Pub. No.: US 2005/0008010 A1
(43) Pub. Date: Jan. 13, 2005

(54) Self-regulating interconnect structure

(75) Inventor: Coke S. Reed, Cranbury, NJ (US)

Correspondence Address: KOESTNER BERTANI LLP, 18662 MACARTHUR BLVD, SUITE 400, IRVINE, CA, 92612, US

(73) Assignee: Interactic Holdings, LLC, New York, NY (US)

(21) Appl. No.: 10/887,762

(22) Filed: Jul. 9, 2004

Related U.S. Application Data
(60) Provisional application No. 60/486,883, filed on Jul. 10, 2003.

(51) Int. Cl. H04L 12/66

(52) U.S. Cl. 370/360; 370/235

(57) ABSTRACT

An interconnect device includes a data switch and a control switch coupled in parallel between multiple input lines and a plurality of output ports. The interconnect device comprises an input logic element coupled between the multiple input lines and the data switch. The input logic element can receive a data stream composed of ordered data segments, insert the data segments into the data switch, and regulate data segment insertion to delay insertion of a data segment subsequent in order until a signal is received designating exit from the data switch of a data segment previous in order.

### RELATED PATENTS AND PATENT APPLICATIONS

The disclosed system and operating method are related to subject matter disclosed in the following patents and patent applications that are incorporated by reference herein in their entirety:
1. U.S. Pat. No. 5,996,020 entitled, “A Multiple Level Minimum Logic Network”, naming Coke S. Reed as inventor;
2. U.S. Pat. No. 6,289,021 entitled, “A Scaleable Low Latency Switch for Usage in an Interconnect Structure”, naming John Hesse as inventor;
3. U.S. patent application Ser. No. 09/693,359 (U.S. Pat. No. 6,754,207) entitled, “Multiple Path Wormhole Interconnect”, naming John Hesse as inventor;
4. U.S. patent application Ser. No. 09/693,357 entitled, “Scalable Wormhole-Routing Concentrator”, naming John Hesse and Coke Reed as inventors;
5. U.S. patent application Ser. No. 09/693,603 entitled, “Scaleable Interconnect Structure for Parallel Computing and Parallel Memory Access”, naming John Hesse and Coke Reed as inventors;
6. U.S. patent application Ser. No. 09/693,358 entitled, “Scalable Interconnect Structure Utilizing Quality-Of-Service Handling”, naming Coke Reed and John Hesse as inventors;
7. U.S. patent application Ser. No. 09/692,073 entitled, “Scalable Method and Apparatus for Increasing Throughput in Multiple Level Minimum Logic Networks Using a Plurality of Control Lines”, naming Coke Reed and John Hesse as inventors;
8. U.S. patent application Ser. No. 09/919,462 entitled, “Means and Apparatus for a Scaleable Congestion Free Switching System with Intelligent Control”, naming John Hesse and Coke Reed as inventors;
9. U.S. patent application Ser. No. 10/123,382 entitled, “A Controlled Shared Memory Smart Switch System”, naming Coke S. Reed and David Murphy as inventors;
10. U.S. patent application Ser. No. xx/xxx,xxx entitled, “Means and Apparatus for a Scaleable Congestion Free Switching System with Intelligent Control II”, naming Coke Reed and David Murphy as inventors;
11. “Means and Apparatus for a Scalable Network for Use in Computing and Data Storage Management” naming Coke Reed and David Murphy as inventors; and
12. “Means and Apparatus for Scalable Distributed Parallel Access Memory Systems with Internet Routing Applications” naming Coke Reed and David Murphy as inventors.

### BACKGROUND

Prior to widespread networking of computing capacity, computers such as traditional mainframes scaled performance by balancing processing power and communications throughput in an environment of predictable workloads. As computing networking has enormously expanded in variety as well as load, multiple-tier server systems distribute communications across a range of architectures and interconnect technologies. The Internet has fundamentally changed the nature of computing management. Previous to widespread Internet usage, all but a fraction of computing was performed local to a particular computer. Widespread Internet connectivity has fundamentally changed usage character so that now most computing is performed over a network. Service providers have responded by improving connectivity, enabling transfer of massive data amounts throughout the world.

The impressive increase in capability and capacity enabled by the evolution from local to highly networked computing brings challenges to providers of computing capability and services. Workloads have evolved from highly predictable to vastly unpredictable. Not only consumers of computing power but all of society has become highly dependent on networked computing and database operations.

One aspect of reliable communications and computing is the efficiency of message communication through the network to transfer data. The traditional “load-store” model for transferring data is insufficient to meet today's networking demands.

### SUMMARY

In accordance with an embodiment of an interconnect device for usage in an interconnect structure. The interconnect device includes a data switch and a control switch coupled in parallel between multiple input lines and a plurality of output ports. The interconnect device comprises an input logic element coupled between the multiple input lines and the data switch. The input logic element can receive a data stream composed of ordered data segments, insert the data segments into the data switch, and regulate data segment insertion to delay insertion of a data segment subsequent in order until a signal is received designating exit from the data switch of a data segment previous in order.

### BRIEF DESCRIPTION OF THE DRAWINGS

Embodiments of the illustrative systems and associated technique relating to both structure and method of operation, may best be understood by referring to the following description and accompanying drawings:

FIG. 1 is a schematic block diagram that illustrates an overview of the system comprising a data switch DS, a control switch CS, auxiliary switch AS, input logic IL, and output switches OS;

FIGS. 2A and 2B are data structure diagrams showing packet segment and control segment formats;

FIG. 3 is a schematic block diagram illustrating a portion of an interconnect system that moves a plurality of packet segments to a single downstream destination and moves a plurality of control packets form the bottom row of the data switch DS to a plurality of input logic devices IL;

FIG. 4 is a schematic block diagram showing control connections between the data switch DS and input logic elements IL with control packets destined to different logic elements passing through a single pin of the chip containing switch DS;

FIGS. 5A, 5B, and 5C are a schematic block diagrams showing various embodiments of multiple computing and data storage devices connected to both a scheduled network and an unscheduled network;

FIG. 6 is a schematic block diagram showing a switch suitable for usage in carrying unscheduled traffic;

FIG. 7 is a schematic block diagram showing a switch suitable to be used for carrying scheduled traffic; and

FIG. 8 is a schematic diagram illustrating connections for delivering data from a scheduled network to devices exterior to the scheduled network.

### DETAILED DESCRIPTION

The disclosed system relates to structures and operating methods for interconnecting a plurality of devices for the purpose of passing data between said devices. Devices that can be interconnected include but are not limited to: 1) computing units such as work stations; 2) processors in a supercomputer; 3) processor and memory modules located on a single chip; 4) storage devices in a storage area network; and 5) portals to a wide area network, a local area network, or the Internet. The disclosed system also can include aspects of self-management of the data passing through the interconnect structure. Self-management can accomplish several functions including: 1) ensuring that individual packets of a message and segments of a packet leave the interconnect structure in the order of entry, and 2) controlling packets entering the interconnect structure prevent overloading of individual output ports.

The interconnect structures described in the related patents and patent applications are excellent for usage in interconnecting a large number devices when low latency and high bandwidth are important. The self-routing characteristics and a capability to simultaneously deliver multiple packets to a selected output port of the referenced interconnect structures and networks can also be favorably exploited.

References 1, 2, 3, 4, 6 and 7 disclose topology, logic, and use of the variations of a revolutionary interconnect structure that is termed a “Multiple Level Minimum Logic” (MLML) network in the first reference and has been referred to elsewhere as the “Data Vortex”. References 8 and 10 show how the Data Vortex can be used to build next generation communication products, for example including routers. A Hybrid Technology Multi Threaded (HTMT) petaflop computer can use an optical version of the MLML network in an architecture in which all message packets are of the same length. Reference 5 teaches a method of parallel computation and parallel memory access within a network.

Reference 11 teaches a method of scheduling messages through an interconnect structure including a Data Vortex data structure. One consequence of the scheduling is a highly desirable capability of guaranteeing that output ports of a scheduled switch are not overloaded and also guaranteeing that message packet segments exit a switch in the same order as the segments entered the switch.

The present disclosure describes a structure and technique for regulating data flow through an interconnect structure or network that eliminates overloading of output ports and ensures that segments of a data packet and packets of a data stream pass through the interconnect structure in the same order as the segments entered the structure.

In some embodiments, the disclosed structure and technique can be configured using the interconnect structures, networks, systems, and techniques described in the referenced and related patents and patent applications to further exploit the performance and advantages of the referenced systems. For example, the present system can be constructed using a Data Vortex switch in a configuration as an unscheduled switch so that overloading of output ports is eliminated and data segments and packets pass through the Data Vortex switch in order. Overloading and/or mis-ordering events that occur with very low probability in systems using structures and methods of the referenced patents and patent applications are eliminated using the structures and methods of the present disclosure.

Because InfiniBand switching standards require that segments leave a switch in the same order as the segments entered the switch, the structures and methods described herein are highly useful in InfiniBand applications.

The present disclosure teaches interconnect structures, networks, and switches, and associated operating methods for regulating data flow through an interconnect structure or switch, in some embodiments a Data Vortex switch, so that output ports do not become overloaded and message packet segments are guaranteed to remain in the same order at entry and exit from the switch. In one embodiment two Data Vortex switches are connected. A first Data Vortex switch is used for data transfer and a second switch is used to regulate the first switch. In a particular configuration, a data switch has N input ports and N output ports. K data transmission lines connect to each of the output ports. Output port overloading and/or data mis-ordering conventionally arises when, over a prolonged time, more than K input ports send data to a single output port.

The following terminology is used in the present description.

A message is a data stream comprising a plurality of packets. A packet is a data stream comprising a plurality of segments. Messages and packets can have different lengths. All segments have the same length. Segments are inserted into the switch at segment insertion times.

For example, a packet P can arrive at a data switch input port IP and the packet P is targeted for output port OP. The packet can include multiple segments arranged in a sequence S₀, S₁, S₂, . . . , S_{J} so that segment S₀ is the first segment to be inserted into the data switch DS; S₁ is the second segment to be inserted into the data switch and so forth whereby S_{J} is the final segment inserted into the data switch. When the segment Sₙ, for entries 0≦n<J, is inserted into the data switch, a lock is placed on input port IP forbidding insertion of Sₙ₊₁ until the lock is removed by a signal indicating that Sₙ has exited the data switch.

A header is attached to the individual segments. The header of a segment has a leading bit set to one to indicate message presence, followed by a binary address of a selected target output port, followed by a binary address of a selected target input port, followed by a single bit set to one. In case multiple data lines are connected to a particular input port, the input lines are distinguished by additional header bits between the address of the input port and the single bit, which functions as a payload.

When the first header bit arrives at the target output port from the data switch, header address bits have been removed by the switch. A packet with a header with a leading bit set to one, followed by the binary address of the input port, followed by a payload of a single bit set to one is called a control packet and is sent through a control switch CS to the input logic unit IL specified in the header of the control packet. The single bit payload arrives at the input logic unit IL and unlocks the control lock so that the next segment of the packet is free to enter data switch DS. When the single payload bit of the control packet exits the data switch, the contents of the payload are sent out of the data switch output port OP to a downstream device. Smooth operation of the system is possible even for short messages in part because the control switch is self routing and has extremely low latency. Moreover, when a group of segments is inserted into the control switch, more segments are never targeted for a single input port than the number of data lines into data switch DS from the input device at input port IP. In case multiple data lines are connected into the data switch, the individual lines can be reached by small crossbars arranged into an auxiliary switch AS. If the data switch has only a single input line from each of the input logic devices IL, the auxiliary switch AS can be omitted. References 10 and 11 describe an example of crossbars in an auxiliary switch AS. In case the data switch DS has N inputs and N outputs and each output has K data lines, the control packet can conveniently be sent through a K·N concentrator prior to sending the control packet into the control switch CS. A suitable concentrator is described in more detail in reference 4.

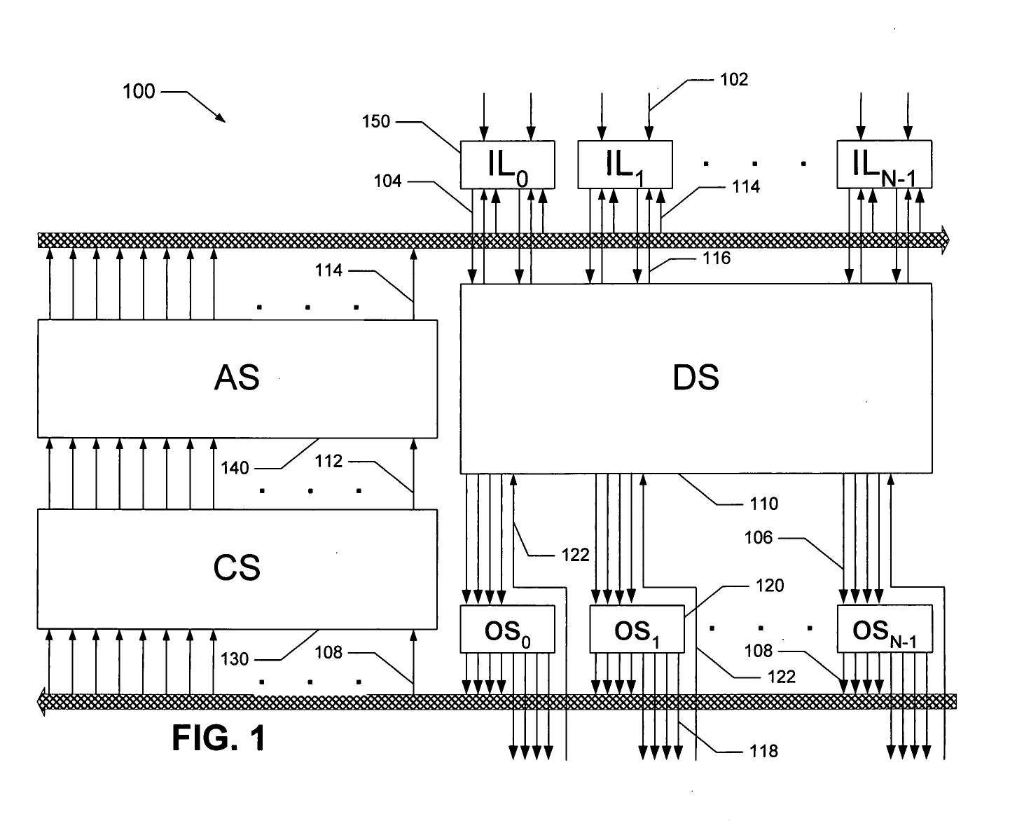

Referring to FIG. 1, a schematic block diagram illustrates an embodiment of an interconnect structure 100 that includes a data switch DS 110 capable of communicating data from a plurality of input lines 102 to a plurality of output lines 118. A plurality of output switches OS 120 are coupled between the data switch DS 110 and the plurality of output lines 118. A control switch CS 130 is coupled between the plurality of input lines 102 and the plurality of output lines 118 in parallel with the data switch DS 110. The control switch CS 130 can regulate data flow to prevent overloading of the output switches OS 120 and ensure that data exits the interconnect structure 100 to the output lines in the order of entry through the input lines.

The illustrative system 100 includes a plurality of networks including the network DS 110 the network CS 130, and the network AS 140. Data enters the system through input lines 102 and exits the system through output lines 118. Data packets arriving on input lines 102 enter input logic units IL 150. The input logic units IL 150 divide the packet into segments of fixed length. The logic unit IL 150 applies a header to a segment prior to sending the segment into the data switch DS 110. The input logic unit IL governs insertion of a first data segment S into the data switch DS 110 and a second segment T into data switch DS 110 when the segment T directly follows segment S and is destined for the same output port as segment S because segments S and T are two adjacent data segments of the same packet or because segment S is the last segment of one packet P and segment T is the first segment of a following packet Q of the same message. When the input logic IL sends S through line 104 into the data switch DS, input logic element IL sets a lock prohibiting the entrance of segment T into data switch DS until input logic element IL receives a signal indicating that segment S has reached an output port of data switch DS.

In some embodiments, the data switch DS 110 can be a Data Vortex type interconnect structure.

A control line 116 from the data switch DS 110 to the input logic IL_{J} may also prevent a signal from entering, for example by sending a one-bit signal to input logic IL_{J} to indicate that the entry node is busy. In a particular embodiment, data in multiple lines 116 can be passed through a reduced number of pins.

The packet segment S, along with other packets from the input logic units, enters the data switch DS 110 at a segment-input insertion time. In a first case, the first bit of segment S can exit data switch DS 110 through line 106 before the beginning of the next segment insertion time or, in a second case, segment S circulates around the data switch through a first-in first-out (FIFO) buffer and, as a result, the first bit of segment S does not exit the data switch before the beginning of the next segment insertion time. In a second case, the number of segments inserted with segment S into data switch DS at the same time segment insertion time exceeds the number of data-carrying lines 106 exiting data switch DS. The system can be designed so that, in the first case, the segment T is allowed to enter data switch DS directly after segment S. In a second case, insertion of segment T is delayed.

In one embodiment, when the insertion of segment T is delayed, the line that carries segment S from input logic unit IL to data switch DS is idle. A single bit sent to an input logic unit IL unit through a line 114 is sufficient to manage data transfer. In a second embodiment, the line that carries segment S from input logic unit IL to data switch DS may be enabled to carry a segment U of a packet R from input logic unit IL to data switch DS when no other segment of packet R presently in the data switch DS. More information is generally sent to the input logic unit IL to enable the additional functionality of the second embodiment.

Data travels on lines 106 from the data switch DS to the output switches OS. As the data traverses the data switch DS 110, output port address information is pared, bit-by-bit while passing through nodes in the data switch DS. When a data segment reaches an output switch, at least a portion of the header is discarded. Output switch OS sends the remainder of the header and a single payload bit through a line 108 to the control switch CS. In some embodiments, the payload bit may be omitted and a timing bit may be used to inform the input logic unit that the data packet segment sent from the input logic unit to the data switch DS has exited the data switch DS. Segments enter the output switch OS at staggered times. Therefore some method of managing the time that the control segments enter the control switch is used. In some embodiments, a concentrator may be incorporated into control switch CS 130 to reduce the number of output lines exiting the control switch in comparison to the number of input lines to the control switch. FIG. 1 shows an embodiment with two data lines 104 from each input logic unit IL 150 to the data switch DS 110 and four data lines 118 leaving the data switch DS 110. The number of data lines 102, 104, 106, and the like are for illustration purposes only. In actual systems, the number of lines may vary.

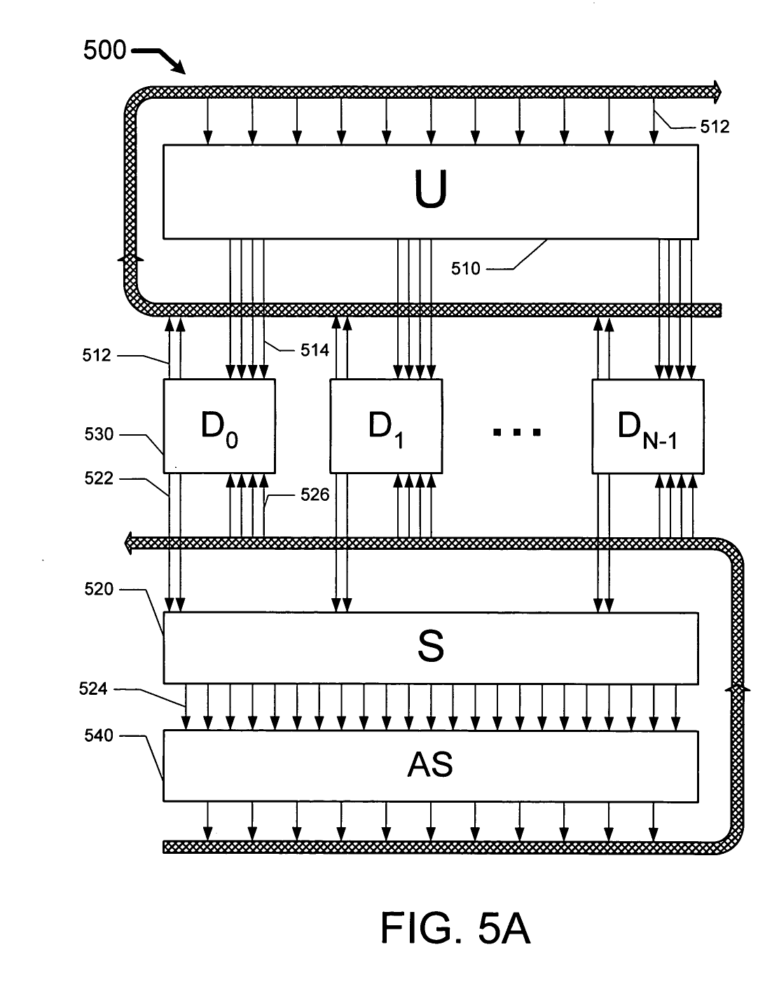

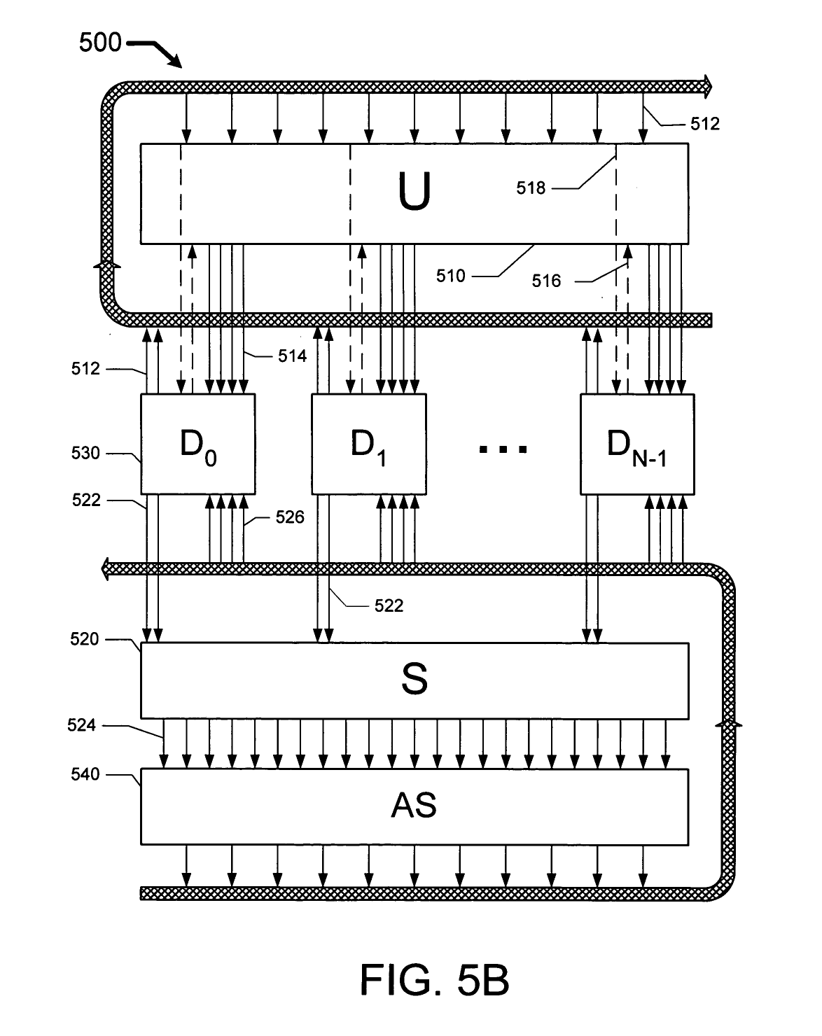

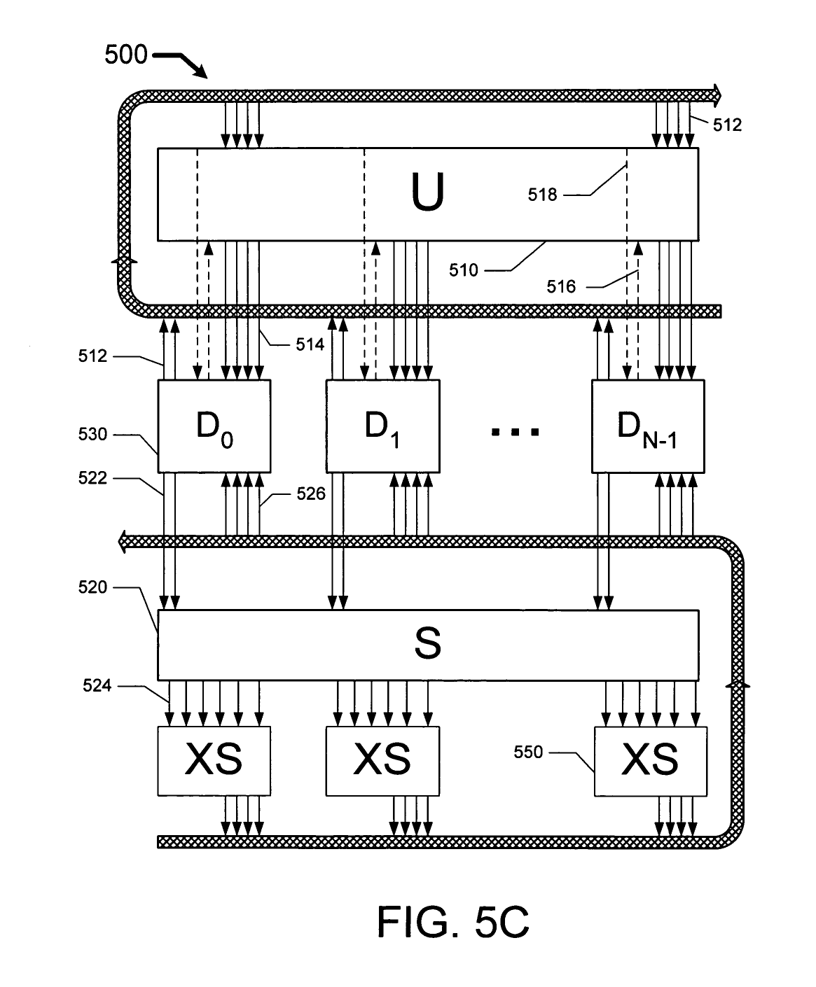

Control segments travel through lines 112 from the control switch CS 130 to the auxiliary switch AS 140. The auxiliary switch may include one or more crossbar switches. Examples of suitable cross-bar switches and timing interfaces between the control switch CS and the auxiliary switch AS are described in more detail in the discussion of FIGS. 5 through 8.

In the depicted embodiment, only a single bit exits the auxiliary switch AS and travels on line 114 to the input logic unit IL 150. The single control bit is used to unlock an input logic gate to enable another segment to flow through that gate into the data switch DS 110.

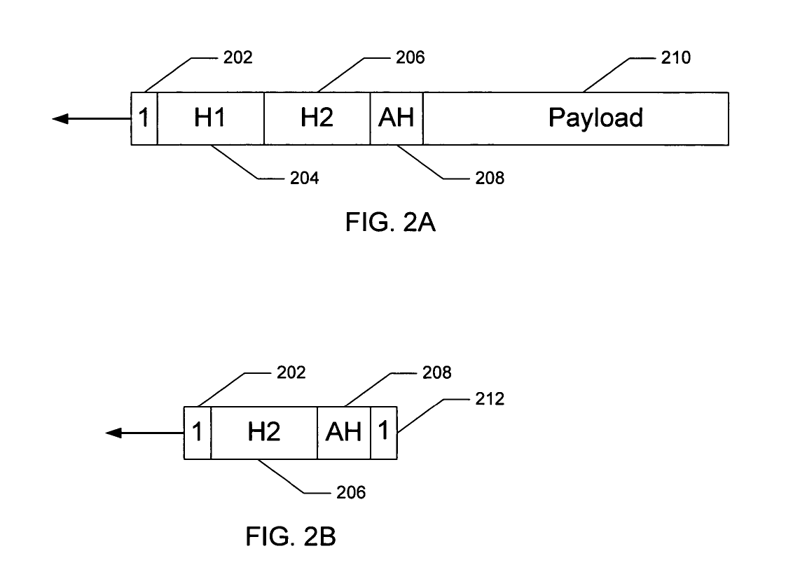

FIG. 2A illustrates a format of a data packet segment that is suitable for usage in the structure 100. FIG. 2B illustrates a format of a control packet suitable for carrying a control signal from an output port of the data switch DS to an input logic unit IL. The first field 202 of the data segment can be a single bit that is always set to one to indicate presence of a packet segment. The second field H1 204 can contain a binary address of the target output port of DS. The third field H2 206 indicates the address of an input port, for example a target input port or the input port that sent the packet. The fourth field AH 208 can be included in configurations that use auxiliary switches and can indicate which of the lines 104 is used to transport the data packet from the input logic unit IL 150 into the data switch DS 110. A fifth field 210 can contain a payload. The header fields can be placed on the packet by the input logic unit IL 150. When the data packet segment arrives at an output switch OS, the header field H1 generally has been removed. The control packet illustrated in FIG. 2B is switched to a line 106 by an output switch OS. The output switch then sends the payload down a line 118.

A control line 112 from the external device to data switch DS is used to prevent packet segments from being sent from data switch DS to the output switch and from the output switch to the external device. In one embodiment, the output switch sends a single-bit set to one at a segment sending time when the output port is not prepared to receive the data (possibly resulting from a full input buffer). In a second embodiment, the external device sends a two-bit locking signal (for example [1,1]) indicating that no data is to be sent until further notice and sends an unlocking signal (for example [1,0]) indicating that data may be sent until the next locking signal is received.

In many embodiments, for example the embodiment shown in FIG. 1, the number of input lines into control switch CS exceeds the number of output lines from control switch CS. Moreover in many embodiments, the number of input lines into data switch DS is greater than the number of output lines from data switch DS so that the output lines can be considered to be lightly loaded. The data packet segments entering a particular output switch comes from different columns of data switch DS so that arrival times are offset by a known time interval. References 10 and 11 teach a method of aligning the data packet segments using first-in first-out (FIFO) buffers having different lengths. Once the packet segments are time-aligned, a concentrator can be used to convert a larger number of lightly loaded lines to a smaller number of more heavily loaded lines. Reference 4 describes a suitable concentrator and operating technique for usage in the interconnect structure and system described herein. A lowest level of a concentrator can also be incorporated as a highest level of the control switch CS.

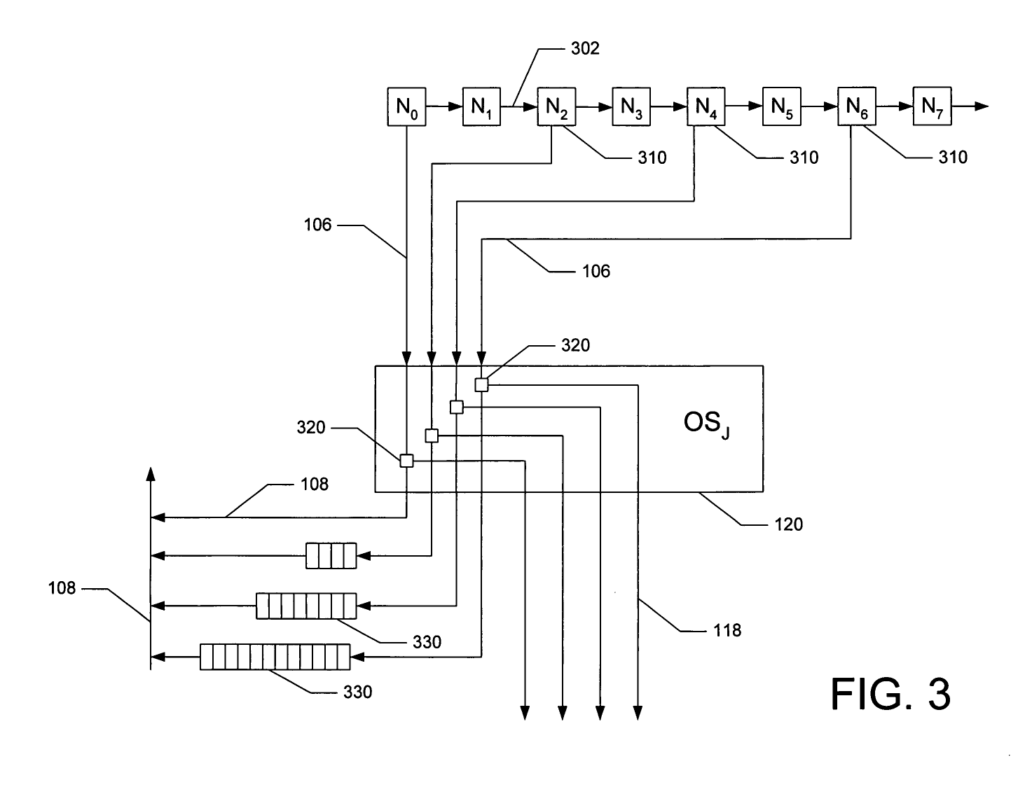

FIG. 3 is a schematic block diagram that illustrates a structure and associated method that transport data from the data switch DS through an output switch OS in a configuration that exploits the extremely short payload of data sent through the control switch CS. Depicted is a portion of the interconnect structure tracking packet segments from the bottom row (row J) of data switch DS to a multiple-line output port OS_{J} 120 and also tracking a plurality of control packets into the control switch. A group of interconnected nodes 310 on the bottom level of a data switch DS are shown interconnected with lines 302. A suitable data switch DS is described in reference 2. Additional lines (not shown) carry data into nodes N from nodes one level above (not shown).

The second listed reference incorporated herein, U.S. Pat. No. 6,289,021, describes multiple-level switches in which the bottom level has multiple output rings. Each node on the output ring can receive data in a bit-serial arrangement, either from a neighboring node on the ring or from a node not on the output ring. The node N_{A} on the bottom output ring is positioned to send data directly to a node N_{A+1}, on the bottom ring. The timing is such that if the first bit of a packet segment arrives at node N_{A} at tick t, also termed time t, and node N_{A} forwards the segment to node N_{A+1}, then the first bit of the segment arrives at node N_{A+1}, at time t+2. Node N_{A+1} is also positioned to receive data from a node distinct from node N_{A}. A segment arriving at node N_{A+1} from a node distinct from node N_{A} also arrives at node N_{A+1} at time t+2.

In the embodiment illustrated in FIG. 3, the data switch DS is a switch of the type taught in incorporated reference 2. Nodes N₀, N₁, . . . N₇ are nodes on the output ring of the data switch DS. The first header bit of a segment arrives at node N₀ at time t. The first header bit of a segment arrives at node N₂ at time t+4. The first header bit of a segment arrives at node N₄ at time t+8. The first header bit of a segment arrives at node N₆ at time t+12. One unit of time corresponds to a tick of a system clock. Data travels from the bottom level nodes on row J to the output switch OS_{J} via lines 106. The output switch OS contains a plurality of smaller switches 320 that direct control packets to the control switch CS and direct the payload of the segment out of the lines 118. In some embodiments, output switch OS_{J} may insert a first header bit and a single data bit on a data packet, a control packet, or both. Various output switch OS_{J} configurations can be implemented that effectively enable construction of the header and data bit. Control packets leave the output switch OSⱼ and pass through first-in first-out (FIFO) buffers 330 having various lengths. The FIFO lengths are determined based on control packet length. In the illustrative example shown in FIG. 3, control packets have length 8. One suitable arrangement has a first field length 1, an H1 field length 5, an AH field length 1, and a payload length 1. A segment with a first bit exiting node N₀ at time 0 proceeds without delay to control switch input port J on line 108 at clock tick 0. A first bit of a segment exits node N₂ at tick 4 and spends an additional four ticks in FIFO 330 so that the segment exiting node N₂ arrives at the control switch input port at tick 8. Accordingly, control segments enter control switch input line J one directly after another. In some embodiments, the control switch can be configured as a Data Vortex interconnect structure and is highly suited to handle the illustrative data transfer. The illustrative system has a control switch that is lightly loaded and carries extremely short messages, for example seven header bits and one payload bit. Therefore, even for a short data segment, the control payload arrives at the proper data switch input logic before the data segment finishes exiting the data switch.

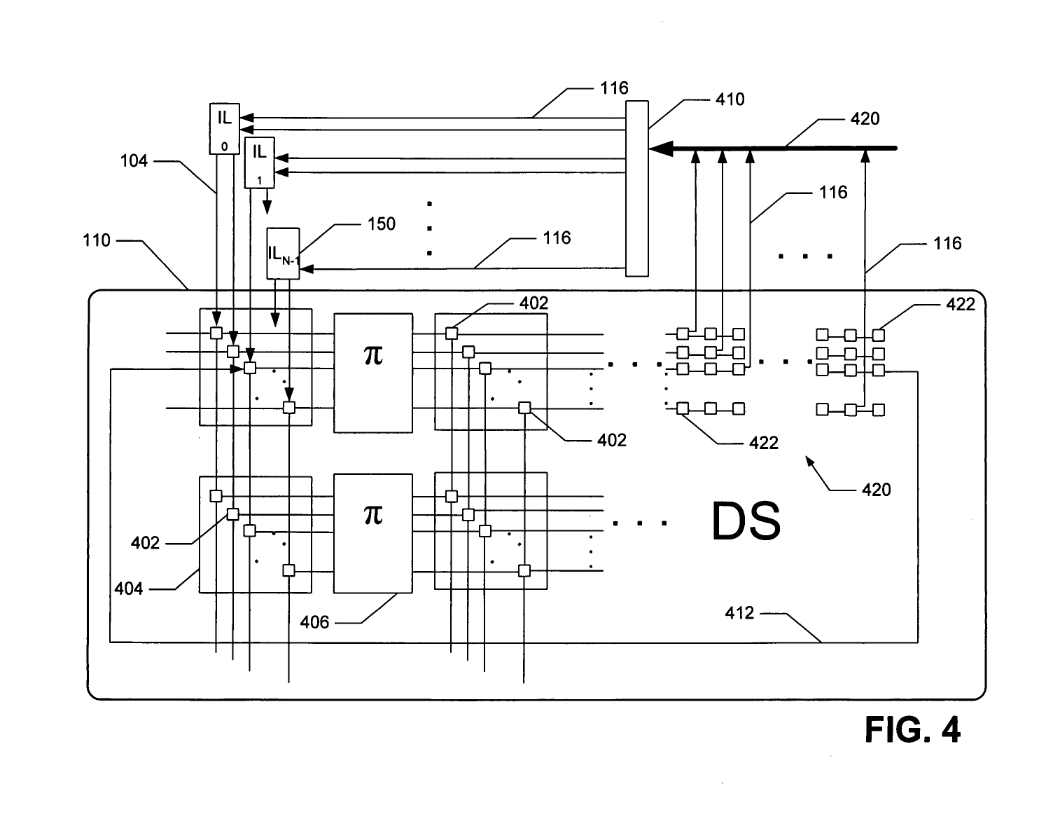

Referring to FIG. 4, a schematic block diagram illustrates an interconnect structure capable of sending control signal data in multiple lines 116 while employing only a small number of output pins, for example only one. In an illustrative embodiment, the control signal data in multiple lines can be passed from an integrated circuit chip containing the data switch 110 to input logic units 150 with a limited pin-out. In addition to receiving control information from lines 116, logic units also receive control information through lines 114 as disclosed hereinbefore. FIG. 4 does not show the lines 114 for receiving control information.

The input logic units insert data into data switch DS 110 through lines 104. The data switch DS can be of the type disclosed in the cited references incorporated herein. The nodes 402 of data switch DS are arranged into node arrays 404. Data can pass from a node array on one level to another array on the same level, or can pass to a node array on a lower level. The data lines connecting same-level node arrays pass through a permutation π 406. In case a data packet segment passes through all of the top level node arrays without dropping to a lower level, then the packet is inserted into a FIFO delay line 420. In the illustrative embodiment the FIFO delay line 420 has single-bit delay elements 422. Because of the permutations π between node arrays, a data packet segment entering a FIFO on the row J typically enters data switch DS in a node on a level K≠J. Data exiting a FIFO re-circulates back into a leftmost node array on lines 412. Although only one of lines 412 is shown in FIG. 4, multiple lines 412 can be and typically are used. The FIFOs are sufficiently long that a data packet segment can “fit around” the Data Vortex. Accordingly, the first bit of a packet segment previously inserted into data switch DS enters the leftmost upper level node array at the same time as the first bit of a second packet segment enters the data switch DS from an input logic unit. To avoid a collision between two data packet segments at an input node on a row R, a control signal 116 is sent from a row R FIFO element to the input logic unit that injects data into row R of the top level of data switch DS. As illustrated in FIG. 4, the control signal from the top row of the FIFO is sent from the leftmost FIFO element. The signal from the next row is sent from the second from the left FIFO element and so forth. The signals form a control data sequence CDS that enters output pin 420. The first bit of the sequence controls the first line from IL₀ to data switch DS. The next bit of the sequence is destined for the second data line into data switch DS. In the case shown in FIG. 4, multiple lines 104 connect input logic unit IL₀ to data switch DS so that the second bit of the sequence CDS is also sent to input logic unit IL₀. If only one line 104 connects the input logic unit IL₀ to data switch DS, the second bit of sequence CDS is sent to input logic unit IL₁. Logic unit 410 receives the bits of sequence CDS in sequential order and sends the individual bits of sequence CDS down the proper control line to be received by the appropriate logic unit. Thus, the purpose of unit 410 is to send the first bit of sequence CDS down the uppermost line 116, to send the second bit down the next-to-top line 116, and so forth, so that each input logic unit receives the proper control signal or signals.

In the illustrative example shown in FIG. 4, more FIFO elements are included than control lines 116, Accordingly, the last bit of the sequence CDS arrives at the proper logic unit in time to be used by that logic unit. If an interconnect is configured with fewer FIFO elements than control lines, multiple pins 420 and a plurality of logic switch units 410 are used to ensure proper timing.

In a first alternate embodiment, data segments from different message packets are interleaved in a single line 104. The message packets are labeled and the labels are carried in the payload of the control packet.

In a second alternate embodiment that is particularly useful for switches in which a large proportion of the data packets from different input ports are targeted to a common output port, the input logic units IL can implement a slightly more complex operating technique. If a particular message packet segment S of a message packet is inserted at a given message insertion time, and a number of segment insertion times pass before the control signal is returned to the input port, then the input port logic can continue to stay latched for several message insertion times. The number of consecutive latched insertion times after receiving the control packet can be a function of the time interval beginning with the packet segment insertion time and ending with the control packet receiving time.

The interconnect structures, networks, and switches described herein may be used in various applications. For example, the structures can be used in the unscheduled portion of the network described in reference 11. In the controlled portion of the reference 11 network, packets with multiple segments are guaranteed to arrive in sequence. For an embodiment using switches disclosed herein in the unscheduled portion of a reference 11 network, then multiple segment packets traversing the unscheduled portion of the network are also guaranteed to have segments arrive in-order, guaranteeing that the processors are always in sequence and never require re-sequencing.

Referring to FIGS. 5A, 5B, and 5C, multiple schematic block diagrams show various embodiments of multiple computing and data storage devices connected to both a scheduled network and an unscheduled network. FIG. 5B depicts the system shown in FIG. 5A with the addition of control lines associated with the unscheduled switch. FIG. 5C shows the system illustrated in FIGS. 5A and 5B with an auxiliary switch decomposed into a set of small switches, for example crossbar switches. Illustrative embodiments relate to a method and means of interconnecting a plurality of devices for the purpose of passing data between said devices. The devices include but are not limited to: 1) computing units such as work stations; 2) processors in a supercomputer; 3) processor and memory modules located on a single chip; 4) storage devices in a storage area network; and 5) portals to a wide area network, a local area network, or the Internet. The system manages data passing through the interconnect structure.

Referring to FIG. 5A, the disclosure describes a system 500 that has a plurality of networks including a network U 510 and a network S 520 with networks S and U connecting a plurality of devices 530. The devices 530 may include devices that are capable of computation; devices that are capable of storing data; devices that are capable of both computation and data storage; and devices that form gateways to other systems, including but not limited to Internet Protocol portals, local and wide area networks, or other types of networks. In general, the devices 530 may include all types of devices that are capable of sending and receiving data.

Unscheduled or Uncontrolled Switch

Unscheduled or uncontrolled network switch U receives data from devices 530 through lines 512. Switch U sends data to devices through lines 514. Scheduled or controlled network switch S 520 receives data from devices through lines 522 and sends data to external devices through auxiliary switches AS 540. Data passes from network S 520 to the auxiliary switch 540 via line 524 and passes from the auxiliary switch 540 to the device D via lines 526.

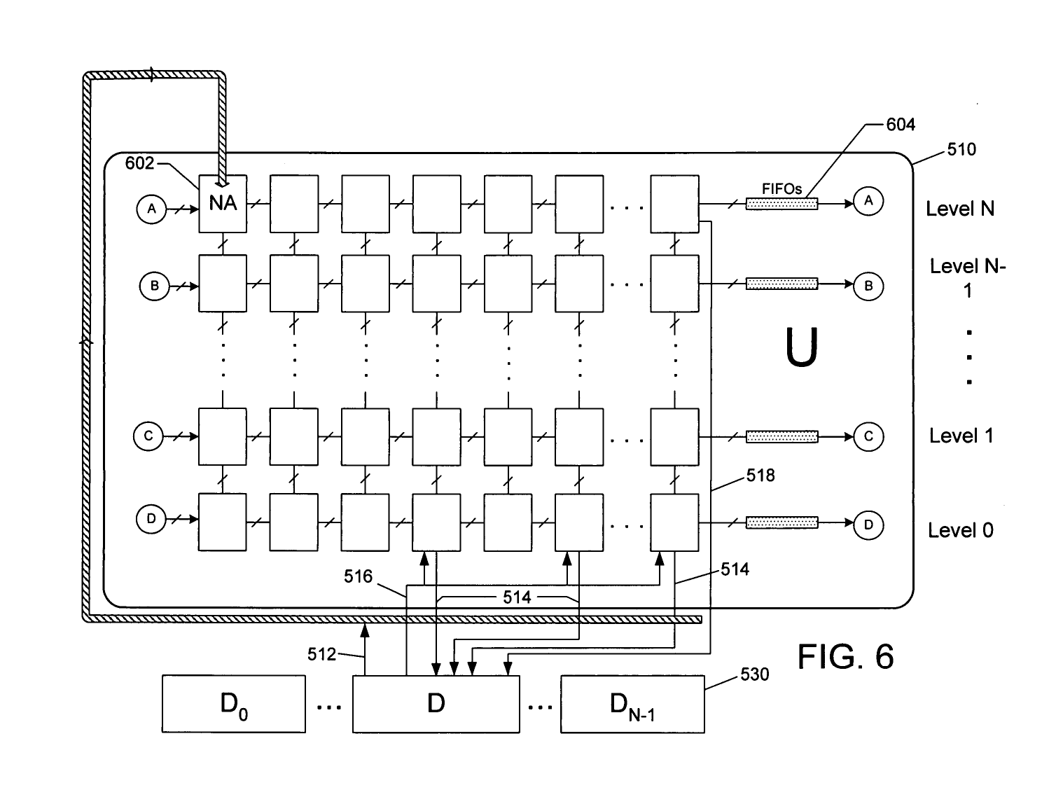

Referring to FIG. 5B in conjunction with FIG. 6, a schematic block diagram shows the interconnection of arrays of nodes NA 662 in a “flat latency switch” of the type disclosed in the related reference 2 that is incorporated by reference into the present disclosure. Network 510 comprises node arrays 602 arranged in rows and columns. Network 510 is well-suited for usage in the unscheduled network U and is used in an illustrative embodiment. Network 510 is self-routing and is capable of simultaneously delivering multiple messages to a selected input port. Moreover, network 510 has high bandwidth and low latency and can be implemented in a size suitable for placement on a single integrated circuit chip. Data is sent into the switch from devices D 530 external to the network 510 through lines 512 at a single column and leaves the switch targeted for devices through lines 514. The lines 514 are positioned to carry data from network U 510 to devices 530 through a plurality of columns. In addition to the data carrying lines, a control line 518 is used for blocking a message from entering the structure into a node in the highest level of the network U 510. Control line 518 is used in case a message packet on the top level of the interconnect is positioned to enter the same node at the same time as a message packet entering the interconnect structure from outside of the network U 510 structure. In case the interconnect structure is implemented on an integrated circuit chip, the control signal 518 can be sent from a top level node to devices 530 that send messages into network U 510.

An embodiment has N pins that carry the control signals to the external devices, with one pin corresponding to each device. In other embodiments, fewer or more pins can be dedicated to the task of carrying control signals.

In another embodiment, that is not shown, a first-in-first-out (FIFO) with a length greater than N and a single pin, or a pair of pins in case differential logic is employed, are used for carrying control signals to the devices D₀, D₁, . . . , D_{N-1}. At a time T₀ the pin carries a control signal to device D₀. At time T₀+1 the pin carries a control signal for device D₁, and so forth, so that at time T₀+k, the pin carries the control signal for device D_{N+k}. The control signals are delivered to a control signal dispersing device, not shown, that delivers the signals to the proper devices.

In a third embodiment, also not shown, the pin that delivers data from line 512 to the network U 510 also passes control signals from network U to the external devices. In the third embodiment, the timing is arranged so that a time interval separates the last bit of one message and the first bit of a next message to allow the pin to carry data in the opposite direction. The second and third embodiments reduce the number of pins. In addition to the control signals from network U to the external devices, control signals connect from the external devices into network U. The purpose of the control signals is to guarantee that the external device input buffers do not overflow. In case the buffers have insufficient capacity to accept additional packets from network U, the external device 530 sends a signal via line 518 to network U to indicate the condition. In a simple embodiment, the signal, for example comprising a single bit, is sent when the device D input buffers have insufficient capacity to hold all the data that can be received in a single cycle through all of the lines 514 from network U 510 to device D 530. If a blocking signal is sent, the signal is broadcast to all of the nodes that are positioned to send data through lines 514. The two techniques for reducing pin count for the control signals out of network U can be used to reduce the pin count for signals into network U.

The Controlled Switch

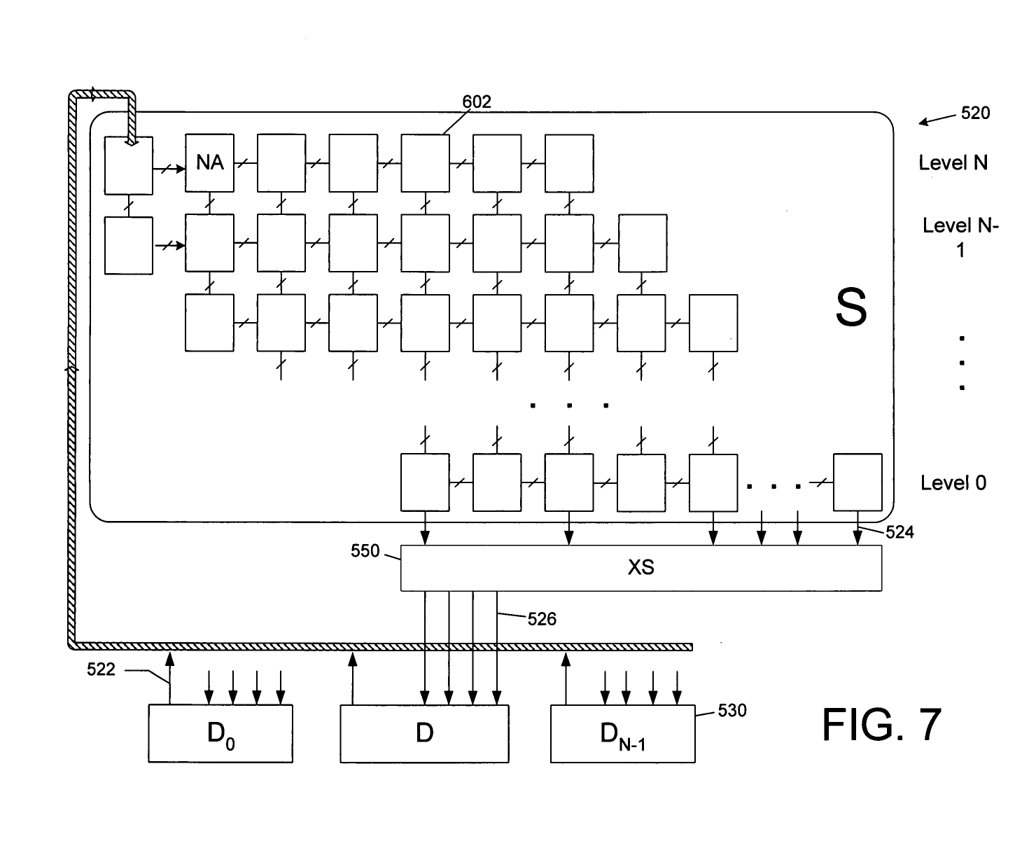

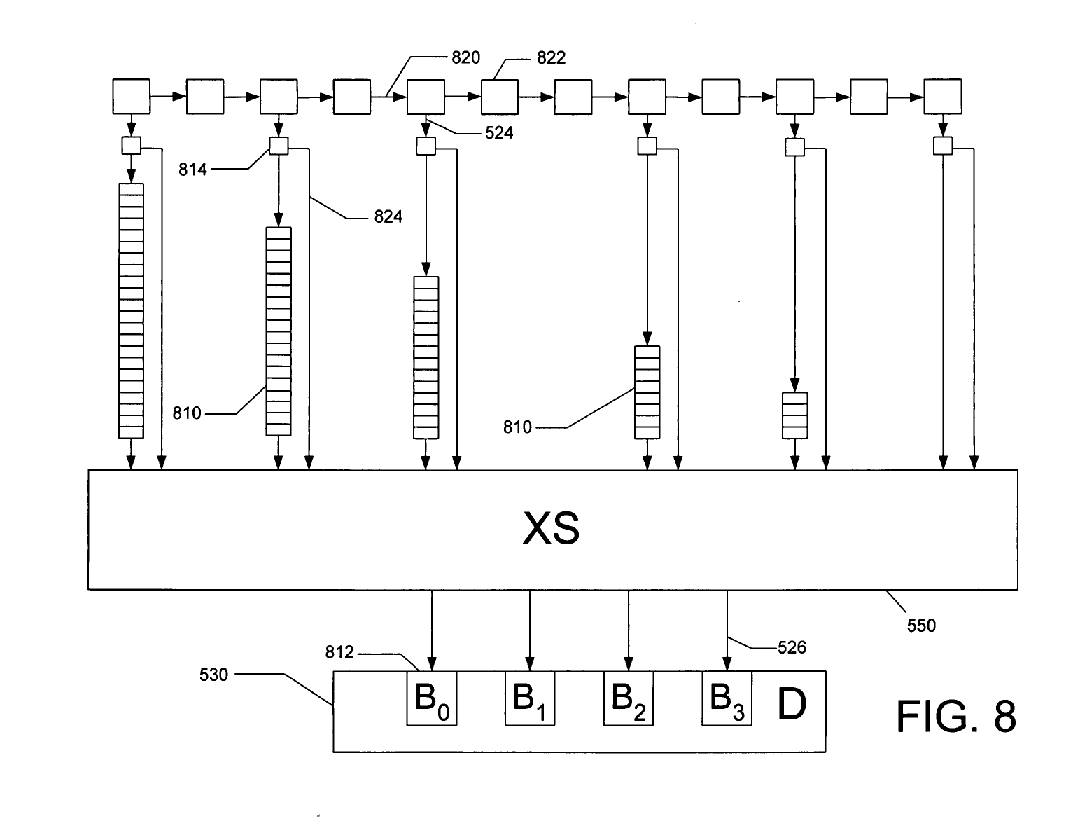

Referring to FIG. 7, a schematic block diagram shows an embodiment of the controlled or scheduled switch or network S 520 that carries scheduled data. The switch 520 comprises interconnected node arrays 602 in a switch that is a subset of the “flat latency switch” described in reference 2. The switch contains some, but not all, of the node arrays of the disclosed flat latency switch. Omitted node arrays are superfluous because the flow into the switch is scheduled so that, based on Monte Carlo simulations, messages never enter the omitted nodes if left in the structure. The switch is highly useful as the center of the switch S 520 and is used accordingly in embodiments that employ one or more of the switches.

Data passes from devices 530 into the switch 520 in a single column through lines 522 and exit the switch 520 in multiple columns through lines 524 into the auxiliary switches AS 540 shown in FIGS. 5A and 5B. The auxiliary switch 540 comprised of a plurality of smaller crossbar switches as illustrated in FIG. 5C. In FIG. 7, one crossbar switch XS 550 receiving data from controlled switch 520 is shown. Data passes from the auxiliary switch 540 to devices 530 external to the switch through lines 526. Switch S 520 may operate without a control signal or a control signal carrying line to warn exterior messages of a collision should the messages enter the switch 520 because messages do not wrap around the top level of the switch 520. For the same reason, the scheduled switch S 520 may operate without first-in-first-out (FIFO) or other buffers.

One method of controlling the traffic through switch S 520 is to send request packets through switch U 510, an effective method for a many applications, including storage array network (SAN) applications. In another application involving parallel computing, including cluster computing), data through switch S is scheduled by a compiler that manages the computation. The system has the flexibility to enable a portion of the scheduled network to be controlled by the network U and a portion of the scheduled network to be controlled by a compiler.

The Auxiliary Output Switch

Referring to FIG. 8, a schematic block diagram shows an interconnection from an output row of the network S to an external device 530 via an auxiliary crossbar switch XS 550. The output row of switch S comprises nodes 822 and connections 820, while the auxiliary crossbar switch XS 550 is composed of a plurality of smaller switches XS 550 shown in FIG. 5A. The output connection from switch S to the targeted devices is more complicated than the output connection from switch U to a targeted external device.

FIG. 8 illustrates the basic functions of a crossbar XS switch module. The switch is illustrated as a 6×4 switch with six input lines 524 from the plurality of nodes 822 on the transmission line 820 to the four input buffers B₀, B₁, B₂ and B₃ of the external device D 530. Of the six input lines, no more than four can be hot, for example carrying data, during a sending cycle. Switch XS may be a simple crossbar switch since each request processor assures that no two packets destined for the same bin can arrive at an output row during any cycle. Since each message packet is targeted for a separate bin in the in the external device 530, the switch is set without conflict. Logic elements 814 set the cross-points defining communication paths. Communication between the logic elements can be avoided since each element controls a single column of the crossbar. Delay FIFOs 810 can be used to synchronize the entrance of segments into the switch. Since two clock ticks are consumed for the header bit of a segment to travel from one node to the next and the two extreme nodes are eleven nodes apart, a delay FIFO of 22 ticks is used for the leftmost node. Other FIFO values reflect the distance of the node from the last node on the line having an input line into the switch. In the illustrative example, switches U, S and the auxiliary switches have a fixed size and the locations of the output ports on the level 0 output row are predetermined. The size and location data is for illustrative purposes only and the concepts disclosed for size apply to systems of other sizes.

In the illustrative example of FIG. 8, a single bottom row of nodes feeds a single device D 530. In other examples, a single row can feed multiple devices. In still other examples multiple rows can feed a single device. Accordingly, the system supports devices of varying sizes and types. A more efficient design generally includes more lines from the bottom line of the network to the auxiliary switch than from the auxiliary switch to the external device. The design removes data from the network in a very efficient manner so that message wrap-around is not possible.

Many control algorithms are usable with the illustrative architecture. Algorithms can be implemented in hardware, software, or a combination of hardware and software.

Using Multiple Switches to Lower Pin Count

Referring to FIG. 5A in conjunction with FIG. 7 and FIG. 8, the schematic block diagrams illustrate an MLML network 520 connecting N external devices D 530. The system 500 shown in FIG. 5A has one line from device D into the network and four lines from the network into device D for each external device D. In an embodiment with auxiliary switch AS 540 on the same integrated circuit chip as a multiple-level-minimum-logic (MLML) network, the network chip of the network S 520 has N input lines and 4·N output lines.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, components, and dimensions can be varied to achieve the desired structure as well as modifications, which are within the scope of the claims. Variations and modifications of the embodiments disclosed herein may also be made while remaining within the scope of the following claims.

1. An interconnect structure comprising:
a data switch capable of communicating data from a plurality of input lines to a plurality of output lines;
a plurality of output switches coupled between the data switch and the plurality of output lines; and
a control switch coupled between the plurality of input lines and the plurality of output lines in parallel with the data switch and capable of regulating data flow to prevent overloading of the output switches and ensure that data exits the interconnect structure to the output lines in the order of entry through the input lines.

2. The interconnect structure according to claim 1 further comprising:
a plurality of data switches communicating data from the plurality of input lines to the plurality of output lines.

3. The interconnect structure according to claim 2 further comprising:
a plurality of control switches coupled between the plurality of input lines and the plurality of output lines in parallel with the plurality of data switches and selectively regulating data among the plurality of data switches.

4. The interconnect structure according to claim 1 wherein:
the data switch is an unscheduled switch.

5. The interconnect structure according to claim 1 wherein the data switch and the control switch are multiple-level minimum-logic network interconnect structures, the data switch for transferring data and the control switch for regulating the data switch.

6. The interconnect structure according to claim 1 further comprising:
at least one input logic element coupled between the plurality of input lines and the data switch, the at least one input logic element being capable of receiving a data stream composed of ordered data segments, inserting the data segments into the data switch, and regulating data segment insertion to delay insertion of a data segment subsequent in order until a signal is received designating exit from the data switch of a data segment previous in order.

7. The interconnect structure according to claim 6 wherein:
the at least one input logic element configures the data into a data structure including a header with a leading bit set to one indicating data presence, a binary address of a target output switch following the leading bit, a binary address of a target input logic element, and a single bit set to one following the binary addresses; and
the data switch removes the binary address of the target output switch during traversal of the data switch by arrival of the leading bit at the target output switch.

8. The interconnect structure according to claim 7 wherein:
the target output switch sends a control packet to the control switch that comprises the leading bit set to one, the binary address of the target input logic element, and a payload of the single bit set to one;
the control switch transfers the control packet to the target input logic element; and
the target input logic element, upon receipt of the payload, unlocks a control lock enabling a next data packet segment to enter the data switch.

9. The interconnect structure according to claim 6 further comprising:
an auxiliary switch coupled between the control switch and the at least one input logic element.

10. The interconnect structure according to claim 6 wherein:
the at least one input logic element is capable of dividing a data packet into a plurality of fixed length data segments, attaching a header to a segment, sending the data segments with header to the data switch, and controls timing of adjacent serial data segments to ensure correct ordering.

11. The interconnect structure according to claim 10 wherein:
the at least one input logic element sends a preceding data segment of pair of adjacent-time data segments to the data switch, sets a lock preventing application of a following data segment of the adjacent-time segment pair, and sustaining the lock until the at least one input logic element receives a signal indicating the preceding segment has reached a target output switch.

12. The interconnect structure according to claim 11 wherein:
the at least one input logic element sets and enforces a delay between segments of adjacent-time segment pairs.

13. The interconnect structure according to claim 6 further comprising:
an auxiliary switch coupled between the control switch and the at least one input logic element, the auxiliary switch comprising a plurality of cross-bar switches.

14. The interconnect structure according to claim 1 further comprising:
a control line from an external device to the data switch that carries a control signal preventing data transmission from the data switch to the external device via a target output switch.

15. The interconnect structure according to claim 1 further comprising:
a concentrator coupled to the control switch that converts a larger number of relatively lightly-loaded lines to a smaller number of relatively heavily-loaded lines.

16. The interconnect structure according to claim 1 further comprising:
a plurality of first-in, first-out FIFO buffers coupled between the plurality of output switches and the control switch, the FIFO buffers having multiple different lengths with various length control packets applied to the FIFO buffers according to length whereby control segments enter the control switch without time overlaps or gaps.

17. The interconnect structure according to claim 1 wherein the data switch further comprises:
a plurality of node arrays arranged in multiple interconnected rows and levels;
a plurality of permutation elements coupling node arrays on a level; and
a plurality of first-in, first-out (FIFO) delay lines coupled on the levels and recircling to form a closed-loop on a level.

18. The interconnect structure according to claim 17 further comprising:
a logic unit coupled to the plurality of input logic elements; and
a plurality of control lines coupling the FIFO delay lines via the logic unit to the plurality of input logic elements and capable of indicating presence of data on a level that has not progressed to a subsequent level whereby the input logic elements can delay injection of data into the data switch and avoid collision.

19. A data structure for usage as a header for a data segment in an interconnect structure comprising a data switch coupled to multiple input lines via a plurality of input ports and coupled to multiple output lines via a plurality of output ports, the interconnect structure further comprising a control switch coupled between the multiple input lines and the multiple output lines in parallel with the data switch, the data structure comprising:
a leading bit set to one indicating data presence;
a binary address of a target output port following the leading bit;
a binary address of a target input port; and
a single bit set to one following the binary addresses.

20. The data structure according to claim 19 further comprising:
a payload field following the single bit.

21. The data structure according to claim 19 further comprising:
for an interconnect structure having a plurality of data lines into an input port of the plurality of input ports, a binary identifier designating a selected data line of the target input port.

22. The data structure according to claim 19 wherein:
the target input port is the input port that sends the data segment to the target output port.

23. An interconnect device for usage in an interconnect structure that includes a data switch and a control switch coupled in parallel between multiple input lines and a plurality of output ports, the interconnect device comprising:
an input logic element coupled between the multiple input lines and the data switch, the input logic element being capable of receiving a data stream composed of ordered data segments, inserting the data segments into the data switch, and regulating data segment insertion to delay insertion of a data segment subsequent in order until a signal is received designating exit from the data switch of a data segment previous in order.

24. The interconnect device according to claim 23 wherein:
the input logic element configures the data into a data structure including a header with a leading bit set to one indicating data presence, a binary address of a target output port following the leading bit, a binary address of a target input logic element, and a single bit set to one following the binary addresses.

25. The interconnect device according to claim 24 wherein:
the target output switch sends a control packet to the control switch that comprises the leading bit set to one, the binary address of the target input logic element, and a payload of the single bit set to one;
the control switch transfers the control packet to the target input logic element; and
the target input logic element, upon receipt of the payload, unlocks a control lock enabling a next data packet segment to enter the data switch.

26. The interconnect device according to claim 23 wherein:
the input logic element is capable of dividing a data packet into a plurality of fixed length data segments, attaching a header to a segment, sending the data segments with header to the data switch, and controls timing of adjacent serial data segments to ensure correct ordering.

27. The interconnect device according to claim 26 wherein:
the input logic element sends a preceding data segment of pair of adjacent-time data segments to the data switch, sets a lock preventing application of a following data segment of the adjacent-time segment pair, and sustaining the lock until the at least one input logic element receives a signal indicating the preceding segment has reached a target output switch.

28. The interconnect device according to claim 27 wherein:
the input logic element sets and enforces a delay between segments of adjacent-time segment pairs.
